(19) United States
(12) Patent Application Publication
(10) Pub. No.: US 2023/0013403 A1
(43) Pub. Date: Jan. 19, 2023

(54) COMPOSITIONS COMPRISING HUMAN MILK OLIGOSACCHARIDES FOR USE IN A SUBJECT TO SUPPORT LANGUAGE DEVELOPMENT

(71) Applicant: SOCIETE DES PRODUITS NESTLE S.A., Vevey (CH)

(72) Inventors: MANJIANG YAO, Ithaca, NY (US); JIAN YAN, Seattle, WA (US); JONAS HAUSER, Lausanne (CH); WEILI LIN, Chapel Hill, NC (US); DI WU, Chapel Hill, NC (US); TENGFEI LI, Chapel Hill, NC (US); ZILIANG ZHU, Chapel Hill, NC (US); SEOYOON CHO, Chapel Hill, NC (US)

(21) Appl. No.: 17/756,987

(22) PCT Filed: Dec. 7, 2020
(86) PCT No.: PCT/EP2020/084814

§ 371 Date: Jun. 7, 2022

Related U.S. Application Data
(60) Provisional application No. 62/945,352, filed on Dec. 9, 2019.

(51) Int. Cl. A23C 9/20; A23L 33/125; A23L 33/00

(52) U.S. Cl. CPC A23C 9/203; A23C 9/206; A23L 33/125; A23L 33/40; A23V 2002/00

(57) ABSTRACT

The present invention relates to a nutritional composition comprising at least one human milk oligosaccharide comprising 3′ sialyllactose (3-SL), 6′ sialyllactose (6-SL), 3-fucosyllactose and any combination thereof for improving language development in a subject, preferably born from a A-tetrasaccharide positive mother and/or the subject fed with a mother's milk rich in A-tetrasaccharide

### FIELD OF THE INVENTION

This invention relates to nutritional compositions comprising human milk oligosaccharides for use in a subject to support language development. In particular, the nutritional composition comprises oligosaccharides comprising 3′ sialyllactose (3-SL), 6′ sialyllactose (6-SL), 3-fucosyllactose (3-FL) and any combination thereof. The language development comprises receptive language and/or expressive language based on a score of Mullen sub-scale.

### BACKGROUND OF THE INVENTION

Identifying the potential relationship between Human milk oligosaccharides (HMOs) and early brain development has gained substantial interests in recent years. Preliminary evidence based on animal studies have implicated that human milk oligosaccharides (HMOs) could play a significant role in the central nervous system.

The potential interactions between HMOs and gut microbiota have been implicated since HMOs are largely metabolized in the intestinal tracts. In contrast, the potential effects of HMOs on brain functional development are less studied. Using chronic oral administration of 2′FL rodents, Vazquez et al (2015) Journal of nutritional biochemistry 26(5):455-465 demonstrated that the treated animals exhibit significantly better learning and working memory functions. Nevertheless, to the best of our knowledge, the present study is the first study reporting human results.

EP 2 117 355 relates to use of a composition comprising non-digestible saccharide selected from the group consisting of galactooligosaccharides (gos), fructooligosaccharides (fos) and fructopolysaccharides for the manufacture of a composition for preventing a decline in or improving one of more of (i) language skills, (ii) communication skills, (iii) social skills and/or (iv) reading skills. This reference reported that composition containing prebiotic oligosaccharides (FOS/GOS) reduces the level of pathogenic Clostridium bacteria and thus is indicative of a positive effect on language skills, communication skills, social skills and/or reading skills.

WO 2014/100022 relates to nutritional composition for use in enhancing learning and memory in an individual, wherein composition comprises at least one HMO. This work shows an example of gamma amino butyric acid (GABA) production by babies fecal microbiota in presence of LNnT. It however fails to show any evidence of the effect of this neurotransmitter on the brain. This is further difficult to expect, considering that GABA has been proposed to not cross the blood brain barrier (Van Gelder and Elliott, 1958 Neurochem. Dec; 3(2):139-43; Kuriyama and Sze, (1971) Neuropharmacology January; 10(1):103-8; Knudsen et al., (1988) Hepatol. 1988 Apr.; 6 (2):187-92). Finally, the example supports a role for LNnT, which is a neutral HMOs, but not of any other HMOs, and while some other HMOs are sharing similarities with LNnT, it is also true that many are dissimilar in either their building block or their structure, rendering the extension of the findings obtained with LNnT to other HMOs difficult to support.

There is a need to deliver such health benefits in the subject in a manner that does not induce side effects and/or in a manner that is easy to deliver, and well accepted by the parents or health care practitioners. There is also a need to deliver such benefits in a manner that does keep the cost of such delivery reasonable and affordable by most.

### SUMMARY OF THE INVENTION

In one aspect, the present invention relates to a nutritional composition comprising at least one human milk oligosaccharide comprising 3′ sialyllactose (3-SL), 6′ sialyllactose (6-SL), 3-fucosyllactose (3-FL) and any combination thereof for improving language development in a subject. The language development comprises receptive language and/or expressive language based on a score of Mullen sub-scale.

In another aspect, the present invention relates to a nutritional composition comprising 3′ sialyllactose (3-SL) for use in language development being expressive language for a subject, born from an A-tetrasaccharide positive mother and/or the subject fed with a mother's milk rich in A-tetrasaccharide.

In another aspect, the present invention relates to a nutritional composition comprising 3-FL for use in language development being expressive language for a subject, born from an A-tetrasaccharide positive mother and/or the subject fed with a mother's milk rich in A-tetrasaccharide.

In another aspect, the present invention relates to a nutritional composition comprising comprising combination of 3′ sialyllactose (3-SL) and 6′ sialyllactose (6-SL) for use in language development being expressive language for a subject, born from a A-tetrasaccharide positive mother and/or the a subject fed with a mother's milk rich in A-tetrasaccharide.

The oligosaccharides of the present invention is/are present in a total amount of from 50 mg to 5000 mg/L for example from 50 mg to 2500 mg/L for example from 60 mg to 2000 mg per L, from 80 mg to 1000 mg per L of the nutritional composition.

In another aspect, the present invention relates to a method of improving language development in a subject comprising the steps of:

(i) obtaining the mother's milk of said infant or young child;

(ii) analyse the milk for A-tetrasacharride and if if present;

(iii) supplement the milk with a nutritional composition comprising at least one human milk oligosaccharide comprising 3′ sialyllactose (3-SL), 6′ sialyllactose (6-SL), 3-fucosyllactose and any combination thereof.

### BRIEF DESCRIPTION OF FIGURES

FIG. 1: Scatterplot of log-transformed 3-SL BM levels with receptive (left) or expressive (right) language t-scores from the MSEL. A significant relationship was observed between the Receptive (p=0.024) subscale and Expressive Language (p=0.00482) subscale t-scores and log-transformed 3-SL BM levels.

FIG. 2: Scatterplot of log-transformed 3-SL BM levels with receptive (left) or expressive (right) language t-scores from the MSEL. A significant relationship between the Expressive Language (p=0.027) subscale t-scores and 3-FL.

FIG. 3: Scatterplot of log-transformed 3-SL BM levels with receptive (left) or expressive (right) language t-scores from the MSEL. A significant relationship was observed between the Receptive (p=0.000847) subscale and Expressive Language (p=0.0027) subscale t-scores and sum of 3-SL+6-SL BM levels.

FIG. 4: Scatterplot of log-transformed 2′FL BM levels with expressive (left) or receptive (right) language t-scores from the MSEL. There was no significant correlation between 2′FL BM levels and either (p>0.1).

FIG. 5: Scatterplot of log-transformed 3-SL BM levels with gross motor (left), visual reception (middle) or fine motor (right) t-scores from the MSEL. There was no significant correlation between 3-SL BM levels and either of the score in these sub-scales (p>0.1).

### DETAILED DESCRIPTION OF THE INVENTION

As used herein, the following terms have the following meanings.

The term “Subject” refers to an infant, young child, small for gestational age (SGA) or a preterm.

The term “infant” means a child under the age of 12 months.

The expression “young child” means a child aged between one and three years, also called toddler.

A “preterm” or “premature” means an infant or young child who was not born at term. Generally it refers to an infant or young child born prior 36 weeks of gestation.

By the expression “small for gestational age” or “SGA” it is referred to an infant or young child who is smaller in size than normal for their gestational age at birth, most commonly defined as a weight below the 10th percentile for the gestational age. In some embodiments, SGA may be associated with Intrauterine growth restriction (IUGR), which refers to a condition in which a foetus is unable to achieve its potential size.

The expression “nutritional composition” means a composition which nourishes a subject. This nutritional composition is usually to be taken orally or intravenously. It may include a lipid or fat source, a carbohydrate source and/or a protein source. In a particular embodiment the nutritional composition is a ready-to-drink composition such as a ready-to-drink formula.

The expression “A-tetrasaccharide positive” refers to a subset population of a subject from mothers secreting A-tetrasaccharide in their milk.

The structure of “A-tetrasaccharide” is α-D-GaINAc-(1→3)-[α-L-Fuc-(1Δ2)]-β-D-Gal-(1→4)-D-Glc

Wherein

GaINAc=N-acetylgalactosamine

Fuc=Fucose

Gal=Galactose

Glc=Glucose

The Term “language development” comprises two parts (i) receptive language and (ii) expressive language and is based on a score of Mullen sub-scale.

The Mullen Scales of Early Learning (MSEL; Mullen, 1995) provides a standardized assessment of language, motor, and perceptual abilities for children of all ability levels through 5 years of age. The revised and updated version yields age-normed t scores, age equivalent scores, and percentile rankings for 5 subdomains: 1) gross motor, 2) fine motor, 3) visual reception, 4) receptive language, and 5) expressive language. Scores from the fine motor, visual reception, receptive language, and expressive language domains can be aggregated to yield an Early Learning Composite or developmental quotient value. It is also common to derive verbal (receptive language age equivalent score+expressive language age equivalent score/chronological age*100) and nonverbal (fine motor age equivalent score+visual reception age equivalent score/chronological age*100) developmental quotient scores from this assessment. The assessment takes between 20 and 45 min, depending on the age of the child. We will implement the MSEL at every behavioral visit between 3 and 60 months of age.

The term “Receptive language” measures a child's ability to process linguistic input is the key function, which include auditory comprehension and auditory sequencing.

The term “Expressive language” measures a child's ability to use language productively, which include speaking, language formation and verbal conceptualization.

In a particular embodiment the nutritional composition of the present invention is a “synthetic nutritional composition”. The expression “synthetic nutritional composition” means a mixture obtained by chemical and/or biological means, which can be chemically identical to the mixture naturally occurring in mammalian milks (i.e. the synthetic nutritional composition is not breast milk).

The expression “infant formula” as used herein refers to a foodstuff intended for particular nutritional use by infants during the first months of life and satisfying by itself the nutritional requirements of this category of person (Article 2(c) of the European Commission Directive 91/321/EEC 2006/141/EC of 22 Dec. 2006 on infant formulae and follow-on formulae). It also refers to a nutritional composition intended for infants and as defined in Codex Alimentarius (Codex STAN 72-1981) and Infant Specialities (incl. Food for Special Medical Purpose). The expression “infant formula” encompasses both “starter infant formula” and “follow-up formula” or “follow-on formula”.

A “follow-up formula” or “follow-on formula” is given from the 6th month onwards and includes growing-up milk. It constitutes the principal liquid element in the progressively diversified diet of this category of person.

The expression “baby food” means a foodstuff intended for particular nutritional use by infants or young children during the first years of life.

The expression “infant cereal composition” means a foodstuff intended for particular nutritional use by infants or young children during the first years of life.

The term “fortifier” refers to liquid or solid nutritional compositions suitable for mixing with breast milk or infant formula.

The “mother's milk” should be understood as the breast milk or the colostrum of the mother.

The term “HMO” or “HMOs” refers to human milk oligosaccharide(s). These carbohydrates are resistant to enzymatic hydrolysis by digestive enzymes (e.g pancreatic and/or brush border), indicating that they may display functions not directly related to their caloric value. It has especially been illustrated that they play a vital role in the early development of infants and young children, such as the maturation of the immune system. Many different kinds of HMOs are found in the human milk. Each individual oligosaccharide is based on a combination of glucose, galactose, sialic acid (N-acetylneuraminic acid), fucose and/or N-acetylglucosamine with many and varied linkages between them, thus accounting for the enormous number of different oligosaccharides in human milk—over 130 such structures have been identified so far. Almost all of them have a lactose moiety at their reducing end while sialic acid and/or fucose (when present) occupy terminal positions at the non-reducing ends. The HMOs can be acidic (e.g. charged sialic acid containing oligosaccharide) or neutral (e.g. fucosylated oligosaccharide). Some examples of HMOs are the fucosylated oligosaccharides, the N-acetylated oligosaccharides and/or the sialylated oligosaccha rides.

A “fucosylated oligosaccharide” is an oligosaccharide having a fucose residue. It has a neutral nature. Some examples are 2-FL (2′ fucosyllactose), 3-FL (3-fucosyllactose). For the present invention, the fucosylated oligosaccharide is 3-FL, preferably for use in language development comprising an expressive language.

A “sialylated oligosaccharide” is a charged sialic acid containing oligosaccharide, i.e. an oligosaccharide having a sialic acid residue. It has an acidic nature. Some examples are 3-SL (3′ sialyllactose) and 6-SL (6′ sialyllactose). The expressions “sialylated oligosaccharide” and “sialyllactose (SL)” can be used interchangeably. The trisaccharide sialyllactose consists of lactose at the reducing terminus and one sialic acid residue at the non-reducing end via an α-2,3 binding or α-2,6 binding, resulting in 3′-sialyllactose (3′-SL) and 6′-sialyllactose (6′-SL), respectively.

In the context of the present disclosure, “3′-sialyllactose” (3′-SL, 3-SL, 3-SL, or 3SL) refers to (6R)-5-Aceta mido-3,5-dideoxy-6-[(1R,2R)-1,2,3-trihydroxypropyl]-(3-L-threo-hex-2-ulopyranonosyl-(2->3)-β-D-galactopyranosyl-(1->4)-D-glucopyra nose (IUPAC), and “6′-sialyllactose” (6′-SL, 6-SL, 6-SL, or 6SL) refers to (6R)-5-Acetamido-3,5-dideoxy-6-[(1R,2R)-1,2,3-trihydroxypropyI]-β-L-threo-hex-2-ulopyranonosyl-(2->6)-β-D-galactopyranosyl-(1->4)-D-glucopyranose (IUPAC).

A “precursor of HMO” is a key compound that intervenes in the manufacture of HMO, such as sialic acid and/or fucose.

All percentages are by weight unless otherwise stated.

In addition, in the context of the invention, the terms “comprising” or “comprises” do not exclude other possible elements. The composition of the present invention, including the many embodiments described herein, can comprise, consist of, or consist essentially of the essential elements and limitations of the invention described herein, as well as any additional or optional ingredients, components, or limitations described herein or otherwise depending on the needs.

Any reference to prior art documents in this specification is not to be considered an admission that such prior art is widely known or forms part of the common general knowledge in the field.

The invention will now be described in further details. It is noted that the various aspects, features, examples and embodiments described in the present application may be compatible and/or combined together. any combination thereof.

The nutritional composition according to the invention can be for example an infant formula, a starter infant formula, a follow-on or follow-up formula, a baby food, an infant cereal composition, a fortifier such as a human milk fortifier, or a supplement. In some particular embodiments, the composition of the invention is an infant formula, a fortifier or a supplement that may be intended for the first 4 or 6 months of age. In a preferred embodiment the nutritional composition of the invention is an infant formula.

In some other embodiments the nutritional composition of the present invention is a fortifier. The fortifier can be a breast milk fortifier (e.g. a human milk fortifier) or a formula fortifier such as an infant formula fortifier or a follow-on/follow-up formula fortifier.

When the nutritional composition is a supplement, it can be provided in the form of unit doses.

The nutritional composition of the present invention can be in solid (e.g. powder), liquid or gelatinous form.

The nutritional composition according to the invention generally contains a protein source. The protein can be in an amount of from 1.5 to 3 g per 100 kcal. In some embodiments, especially when the composition is intended for premature infants, the protein amount can be between 2.4 and 4 g/100 kcal or more than 3.6 g/100 kcal. In some other embodiments the protein amount can be below 2.0 g per 100 kcal, e.g. between 1.8 to 2 g/100 kcal, or in an amount below 1.8 g per 100 kcal.

The type of protein is not believed to be critical to the present invention provided that the minimum requirements for essential amino acid content are met and satisfactory growth is ensured. Thus, protein sources based on whey, casein and mixtures thereof may be used as well as protein sources based on soy. As far as whey proteins are concerned, the protein source may be based on acid whey or sweet whey or mixtures thereof and may include alpha-lactalbumin and beta-lactoglobulin in any desired proportions.

In some advantageous embodiments the protein source is whey predominant (i.e. more than 50% of proteins are coming from whey proteins, such as 60% or 70%).

The proteins may be intact or hydrolysed or a mixture of intact and hydrolysed proteins. By the term “intact” is meant that the main part of the proteins are intact, i.e. the molecular structure is not altered, for example at least 80% of the proteins are not altered, such as at least 85% of the proteins are not altered, preferably at least 90% of the proteins are not altered, even more preferably at least 95% of the proteins are not altered, such as at least 98% of the proteins are not altered. In a particular embodiment, 100% of the proteins are not altered.

The term “hydrolysed” means in the context of the present invention a protein which has been hydrolysed or broken down into its component amino acids.

In one particular embodiment the proteins of the nutritional composition are hydrolyzed, fully hydrolyzed or partially hydrolyzed. The degree of hydrolysis (DH) of the protein can be between 8 and 40, or between 20 and 60 or between 20 and 80 or more than 10, 20, 40, 60, 80 or 90.

In a particular embodiment the nutritional composition according to the invention is a hypoallergenic composition. In another particular embodiment the composition according to the invention is a hypoallergenic nutritional composition.

The nutritional composition according to the present invention generally contains a carbohydrate source. This is particularly preferable in the case where the nutritional composition of the invention is an infant formula. In this case, any carbohydrate source conventionally found in infant formulae such as lactose, sucrose, saccharose, maltodextrin, starch and mixtures thereof may be used although one of the preferred sources of carbohydrates is lactose.

The nutritional composition according to the present invention generally contains a source of lipids. This is particularly relevant if the nutritional composition of the invention is an infant formula. In this case, the lipid source may be any lipid or fat which is suitable for use in infant formulae. Some suitable fat sources include palm oil, high oleic sunflower oil and high oleic safflower oil. The essential fatty acids linoleic and α-linolenic acid may also be added, as well small amounts of oils containing high quantities of preformed arachidonic acid and docosahexaenoic acid such as fish oils or microbial oils. The fat source may have a ratio of n-6 to n-3 fatty acids of about 5:1 to about 15:1; for example about 8:1 to about 10:1.

The nutritional composition of the invention may also contain all vitamins and minerals understood to be essential in the daily diet and in nutritionally significant amounts. Minimum requirements have been established for certain vitamins and minerals. Examples of minerals, vitamins and other nutrients optionally present in the composition of the invention include vitamin A, vitamin B1, vitamin B2, vitamin B6, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chlorine, potassium, sodium, selenium, chromium, molybdenum, taurine, and L-carnitine. Minerals are usually added in salt form. The presence and amounts of specific minerals and other vitamins will vary depending on the intended population.

If necessary, the nutritional composition of the invention may contain emulsifiers and stabilisers such as soy, lecithin, citric acid esters of mono- and diglycerides, and the like.

The nutritional composition of the invention may also contain other substances which may have a beneficial effect such as lactoferrin, nucleotides, nucleosides, and the like.

The nutritional composition of the invention may also contain carotenoid(s). In some particular embodiments of the invention, the nutritional composition of the invention does not comprise any carotenoid.

If the final product is to be a powder, the homogenised mixture is transferred to a suitable drying apparatus such as a spray dryer or freeze dryer and converted to powder.

The powder should have a moisture content of less than about 5% by weight. The sialylated oligosaccharide(s) may also or alternatively be added at this stage by dry-mixing or by blending them in a syrup form of crystals, along with the probiotic strain(s) (if used), and the mixture is spray-dried or freeze-dried.

If a liquid composition is preferred, the homogenised mixture may be sterilised then aseptically filled into suitable containers or may be first filled into the containers and then retorted.

In another embodiment, the composition of the invention may be a supplement. The supplement may be in the form of tablets, capsules, pastilles or a liquid for example. The supplement may further contain protective hydrocolloids (such as gums, proteins, modified starches), binders, film forming agents, encapsulating agents/materials, wall/shell materials, matrix compounds, coatings, emulsifiers, surface active agents, solubilizing agents (oils, fats, waxes, lecithins etc.), adsorbents, carriers, fillers, co-compounds, dispersing agents, wetting agents, processing aids (solvents), flowing agents, taste masking agents, weighting agents, jellifying agents and gel forming agents. The supplement may also contain conventional pharmaceutical additives and adjuvants, excipients and diluents, including, but not limited to, water, gelatine of any origin, vegetable gums, lignin-sulfonate, talc, sugars, starch, gum arabic, vegetable oils, polyalkylene glycols, flavouring agents, preservatives, stabilizers, emulsifying agents, buffers, lubricants, colorants, wetting agents, fillers, and the like.

Further, the supplement may contain an organic or inorganic carrier material suitable for oral or parenteral administration as well as vitamins, minerals trace elements and other micronutrients in accordance with the recommendations of Government bodies such as the USRDA.

The nutritional composition according to the invention is for use in infants or young children. The infants or young children may be born term or preterm. In a particular embodiment the nutritional composition of the invention is for use in infants or young children that were born preterm. Preterm infants may be at increased risk of poor nutrient utilization, impaired lean body mass growth, fat accumulation in the visceral area and metabolic disease later in life. So in a particular embodiment the nutritional composition of the invention is for use in preterm infants.

The nutritional composition of the present invention may also be used in an infant or a young child that was born by C-section or that was vaginally delivered.

In some embodiments the nutritional composition according to the invention can be for use before and/or during the weaning period.

In some embodiments the nutritional composition according to the invention is for use in a subject at risk and/or in need.

The subject at risk and/or in need may be bottle-fed and/or formula-fed. The infants or young children at risk and/or in need may be infants or young children who have difficulties in expressive or receptive language.

In one embodiment the composition of the invention is given to the infant or young child as a supplementary composition to the mother's milk. In some embodiments the infant or young child receives the mother's milk during at least the first 2 weeks, first 1, 2, 4, or 6 months. In one embodiment the nutritional composition of the invention is given to the infant or young child after such period of mother's nutrition, or is given together with such period of mother's milk nutrition. In another embodiment the composition is given to the infant or young child as the sole or primary nutritional composition during at least one period of time, e.g. after the 1^{st}, 2^{nd} or 4^{th} month of life, during at least 1, 2, 4 or 6 months.

In one embodiment the nutritional composition of the invention is a complete nutritional composition (fulfilling all or most of the nutritional needs of the subject). In another embodiment the nutrition composition is a supplement or a fortifier intended for example to supplement human milk or to supplement an infant formula or a follow-on formula.

The different embodiments, details and examples previously described in the specification (e.g. related to the types and amounts of oligosaccharide, the nutritional composition, the administration, the targeted population . . . ) also apply to all these other objects.

### EXAMPLES

The following examples illustrate some specific embodiments of the composition for use according to the present invention. The examples are given solely for the purpose of illustration and are not to be construed as limitations of the present invention, as many variations thereof are possible without departing from the spirit of the invention.

In this study, we leveraged the UNC/UMN Baby Connectome Project (BCP) published in Neuroimage 2019:Vol 185: 891-905, aiming to longitudinally characterize early brain development, where typically developing children from 0-5 years of age were enrolled, longitudinal MR imaging was conducted, and Mullen Scales of Early Learning (MSEL) were administered at each visit. The BCP study was further supplemented by collecting breast milk samples from the mothers whose children were breast-fed at the time of study visit (BCP-Enriched). To this end, we aimed to determine if associations exist between HMOs and early brain functional development using MSEL.

Methods: A subset of typically developing children (n=99) enrolled in the BCP who were breast-fed at the time of visit were included in this study (age=2.9-24.3 months and mean=9.88 months). MSEL were administered for each infant and breast milk samples (BMs; n=191) were obtained from the mothers whose children were included in this study. The collected BMs were analyzed for HMOs, including 2′-Fucosyllactose (2FL), 3′-Fucosyllactose (3FL), 3′-Sialyllactose (3SL), 6′-Sialyllactose (6SL), Lacto-N-tetraose (LNT), Lacto-N-neotetraose (LNnT), Lacto-N-fucopentaose I (LNFP1), and A-Tetrasaccharide. To assess the potential association between HMOs and brain functional development (Mullen), age effects of all HMOs were removed first using regression spline. After examining the age-adjusted HMO data, it was deemed that a log-transformation is needed for 3-SL to minimize heteroskedasticity and satisfy linear relationship of a linear model. The association between each of eight age adjusted HMOs and concurrently collected age-adjusted MSEL (as the response variable) was tested using a random linear mixed effects model with both the infant IDs and the examiner IDs as random effects. The potential batch and site effects were also controlled.

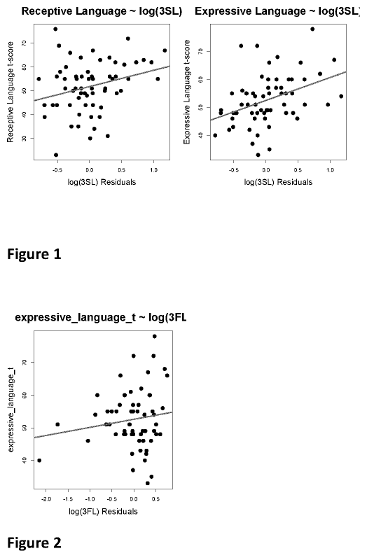

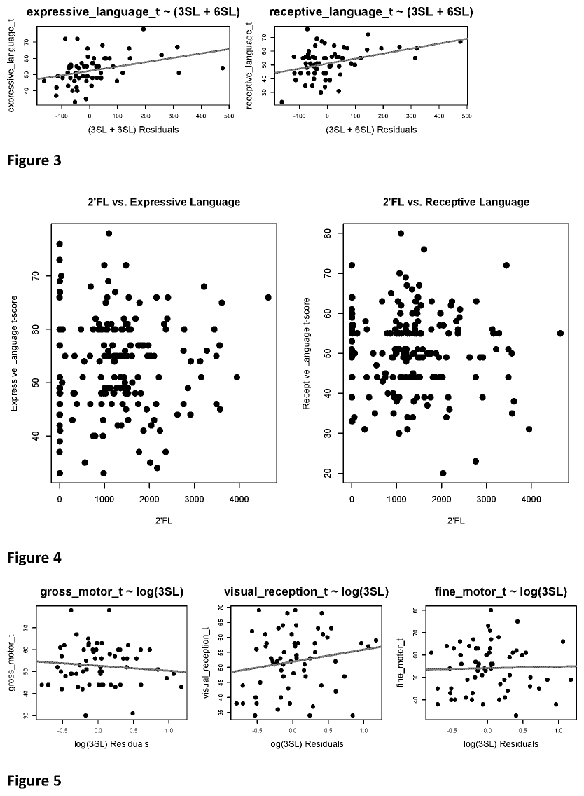

A significant association between 3-SL and language functions (receptive and expressive language) was observed in a model using A-tetrasaccharide positive mothers after including random intercepts for both infants and examiners and controlling all the possible confounders and, by removing the age effect of HMOs and including both batch and site effects in the model (FIG. 1). In addition, although log-transform was employed for 3-SL, the observed association remains without the log-transform. In fact, the relation is stronger without log-transforming 3-SL. The study also showed strong correlation between sum of 3-SL+6-SL and language functions (receptive and expressive languages, FIG. 2) as well as between 3FL and language function (expressive language, FIG. 3). The study also showed no correlation for other analysed HMOs in particular 2FL (FIG. 4), LNnT, LNFP1, A-tetrasaccharide and LNT. The Mullen scale also generated performance evaluation in three other sub-scales (gross motor, visual reception and fine motor, FIG. 5 example for 3-SL) which all failed to be significantly correlated with any of the analysed HMOs (p>0.1).

1. A method for improving language development in a subject comprising administering a nutritional composition comprising at least one human milk oligosaccharide comprising 3′ sialyllactose (3-SL), 6′ sialyllactose (6-SL), 3-fucosyllactose and any combination thereof.

2. The method of claim 1, wherein the language development comprises receptive language and/or expressive language based on a score of Mullen sub-scale.

3. The method of claim 1, wherein the human milk oligosaccharide comprising 3′ sialyllactose (3-SL).

4. The method of claim 1, wherein the human milk oligosaccharide comprises a combination of 3′ sialyllactose (3-SL), 6′ sialyllactose (6-SL).

5. The method of claim 1, wherein the human milk oligosaccharide comprising 3-fucosyllactose (3-FL) and language development is expressive language.

6. The method according to claim 1, wherein the subject are born from a A-tetrasaccharide positive mother and/or the subject are fed with a mother's milk containing in A-tetrasaccharide.

7. The method according to claim 1, wherein the oligosaccharide(s) is/are present in a total amount of from 50 mg to 5000 mg/L of the nutritional composition.

8. The method according to claim 1, wherein said nutritional composition is selected from the group consisting of an infant formula, a starter infant formula, a follow-on or follow-up infant formula, a baby food, an infant cereal composition, a fortifier and a supplement.

9. A method of improving language development in a subject comprising the steps of:
obtaining the mother's milk of said infant or young child;
(ii) analysing the milk for A-tetrasacharride and if present;
and (iii) supplement the milk with a nutritional composition comprising at least one human milk oligosaccharide (HMO) comprising 3′ sialyllactose (3-SL), 6′ sialyllactose (6-SL), 3-fucosyllactose and any combination thereof.

10. The method of claim 9, wherein the HMO comprises 3-SL.

11. The method of claim 9, wherein the human milk oligosaccharide comprises a combination of 3′ sialyllactose (3-SL), 6′ sialyllactose (6-SL).

12. The method of claim 9, wherein the HMO comprises 3-fucosyllactose (3-FL) and language development is expressive language.
